(19) United States
(12) Patent Application Publication
(10) Pub. No.: US 2024/0317784 A1
(43) Pub. Date: Sep. 26, 2024

(54) PROCESS FOR THE SYNTHESIS OF 4-((R)-2-{[6-((S)-3-METHOXY-PYRROLIDIN-1-YL)-2-PHENYL-PYRIMIDINE-4-CARBONYL]-AMINO}-3-PHOSPHONO-PROPIONYL)-PIPERAZINE-1-CARBOXYLIC ACID BUTYL ESTER

(71) Applicant: Viatris Asia Pacific Pte. Ltd., Singapore (SG)

(72) Inventors: Nicole BLUMER, Allschwil (CH); Romain CLAVEAU, Craigavon (GB); Fabian FEYEN, Allschwil (CH); Leanne HALL, Craigavon (GB); Stephen HUGHES, Craigavon (GB); Stefan REBER, Allschwil (CH)

(21) Appl. No.: 18/579,110

(22) PCT Filed: Jul. 11, 2022
(86) PCT No.: PCT/EP2022/069238

§ 371 Date: Jan. 12, 2024

(30) Foreign Application Priority Data
Jul. 13, 2021 (WO) PCT/EP2021/069486

(51) Int. Cl. C07F 9/6558

(52) U.S. Cl. CPC C07F 9/65583; C07B 2200/13

(57) ABSTRACT

The present invention relates to a process for the synthesis of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester, or of a hydrochloride salt thereof; and to a crystalline form of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride.

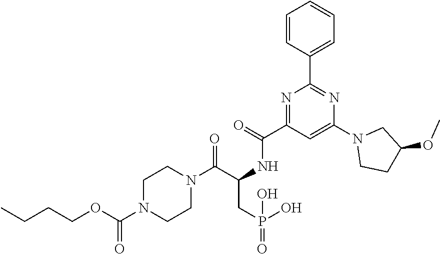 [SMILES: CCCCOC(=O)N1CCN(C(=O)[C@H](CP(=O)(O)O)NC(=O)c2cc(N3CC[C@H](OC)C3)nc(-c3ccccc3)n2)CC1]

The present invention relates to a process for the synthesis of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester (hereinafter also referred to as “COMPOUND”, also known as selatogrel), or of a hydrochloride salt thereof; to a crystalline form of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride (hereinafter also referred to as “COMPOUND-HCl”), and to the crystalline form of COMPOUND-HCl for use as a medicament or for use in the preparation of a medicament.

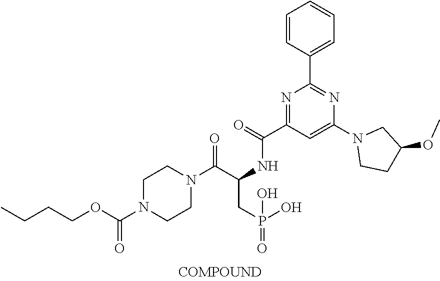 [SMILES: CCCCOC(=O)N1CCN(C(=O)[C@H](CP(=O)(O)O)NC(=O)c2cc(N3CC[C@H](OC)C3)nc(-c3ccccc3)n2)CC1]

The preparation and the medical use of COMPOUND is described in WO 2009/069100; WO 2018/167139; Baldoni D et al., Clin Drug Investig (2014), 34(11), 807-818; Caroff E et al., J. Med. Chem. (2015), 58, 9133-9153; Storey R F et al., European Heart Journal, ehz807, doi:10.1093/eurheartj/ehz807; and Sinnaeve P R et al, J Am Coll Cardiol (2020), 75 (20), 2588-97 (doi.org/10.1016/j.jacc.2020.03.059).

For instance, COMPOUND-HCl can be prepared according to the procedure shown in Scheme 1: Compound 3 can be obtained by amide coupling of piperazine-1-carboxylic acid butyl ester, or its hydrochloride salt, with (R)-2-tert-butoxycarbonylamino-3-(diethoxy-phosphoryl)-propionic acid (compound 2) in the presence of a coupling agent such as T3P or EDC, HOBt. The amino protecting group in compound 3 can be removed under suitable acidic conditions such as TFA in DCM or HCl in dioxane to give 4-[(R)-2-amino-3-(diethoxy-phosphoryl)-propionyl]-piperazine-1-carboxylic acid butyl ester (compound 4). Compound 4 can be coupled to (S)-6-(3-methoxypyrrolidin-1-yl)-2-phenylpyrimidine-4-carboxylic acid sodium salt (compound 6) in the presence of a coupling reagent like EDC, HOBt to give compound 7. Compound 6 is for instance obtainable by saponification of (S)-6-(3-methoxypyrrolidin-1-yl)-2-phenylpyrimidine-4-carbonitrile (compound 5) with a base like aqueous sodium hydroxide solution in a solvent like 2-propanol.

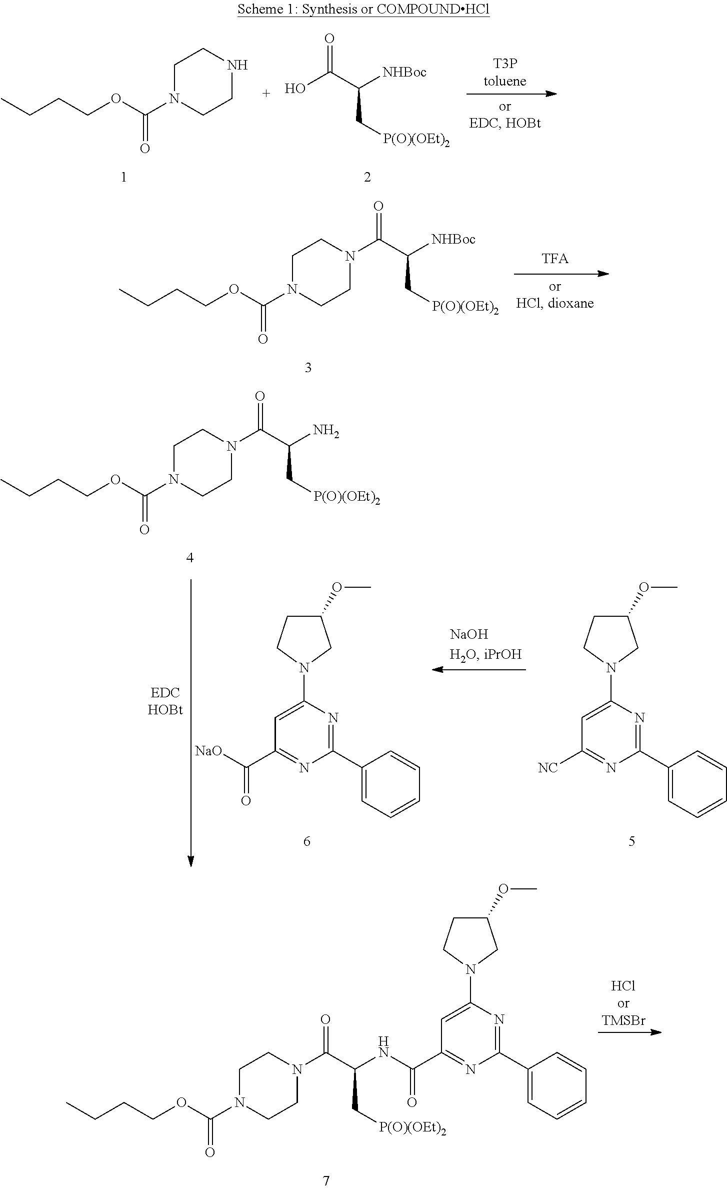

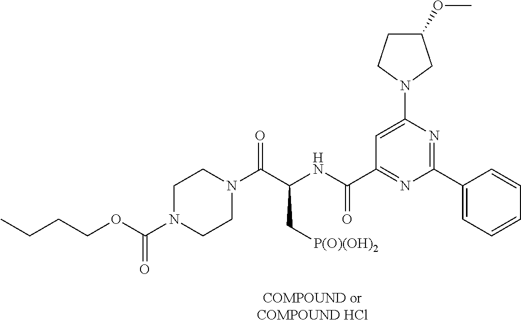

COMPOUND can be prepared for instance from 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester (compound 7) by treatment with TMSBr in acetonitrile and purification with column chromatography on reverse phase (Caroff E et al., J. Med. Chem. (2015), 58, 9133-9153). For large scale synthesis this process has the disadvantages of using large amounts of expensive TMSBr for the deprotection and of a purification step based on column chromatography. These disadvantages can be overcome by the preparation of COMPOUND-HCl by deprotection of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester with concentrated aqueous hydrochloride acid in DCM/THF mixtures and crystallization of the obtained product as described in WO 2018/055016. Even if this process is better suitable for large scale synthesis, it was found that COMPOUND is hydrolyzed to a significant extent under these reaction conditions to (R)-2-(6-((S)-3-methoxypyrrolidin-1-yl)-2-phenylpyrimidine-4-carboxamido)-3-phosphonopropanoic acid (hereinafter also referred to as “HYDROLYSIS PRODUCT”). For instance, a solution of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester in DCM (4 vol) and 32% w/w aqueous HCl (3.6 vol) resulted after stirring for 4 hours at RT in a mixture of 2.8%-a/a HYDROLYSIS PRODUCT and 93.5%-a/a COMPOUND-HCl as analysed by HPLC. After 20 hours the amount of HYDROLYSIS PRODUCT in the mixture even increased to 15.2%-a/a. The deprotection in concentrated aqueous hydrochloride acid has thus the disadvantage of a fast decomposition of the desired product, requires a more intense purification and results in lower yields.

Surprisingly, it was found that the amount of the side-product (R)-2-(6-((S)-3-methoxypyrrolidin-1-yl)-2-phenylpyrimidine-4-carboxamido)-3-phosphonopropanoic acid could be significantly reduced and COMPOUND-HCl could be obtained in high yields and good reaction rates if the reaction is performed with hydrochloride in specific organic solvents containing only catalytic amounts of water. Whereas the reaction is either very slow and/or results in large amounts of side-products (for instance with HCl in solvents like heptane, acetonitrile, 2-methyl-tetrahydrofuran, or ethanol), it gives surprisingly good results with HCl in toluene, acetone, carboxylic esters and especially carboxylic acids (e.g. acetic acid).

### DESCRIPTION OF THE FIGURES

FIG. 1 shows the X-ray powder diffraction diagram of COMPOUND-HCl in the crystalline form (I), wherein the X-ray powder diffraction diagram was measured with the XRPD method described in the experimental part and is displayed against Cu Kα radiation. The X-ray diffraction diagram shows peaks having a relative intensity, as compared to the most intense peak in the diagram, of the following percentages (relative peak intensities given in parenthesis) at the indicated angles of refraction 2theta (selected peaks from the range 3-28° 2theta with relative intensity larger than 10% are reported): 3.7° (12%), 5.1° (50%), 5.7° (93%), 5.9° (100%), 10.2° (17%), 10.4° (16%), 10.7° (25%), 11.0° (20%), 12.9° (28%), 14.7° (13%), 15.2° (32%), 15.4° (26%), 18.0° (26%), 18.3° (23%), 18.8° (26%), 19.4° (21%), 19.6° (31%), 20.2° (58%), 21.0° (54%), 21.3° (49%), 22.2° (45%), 22.6° (33%), 25.2° (40%), and 26.4° (18%).

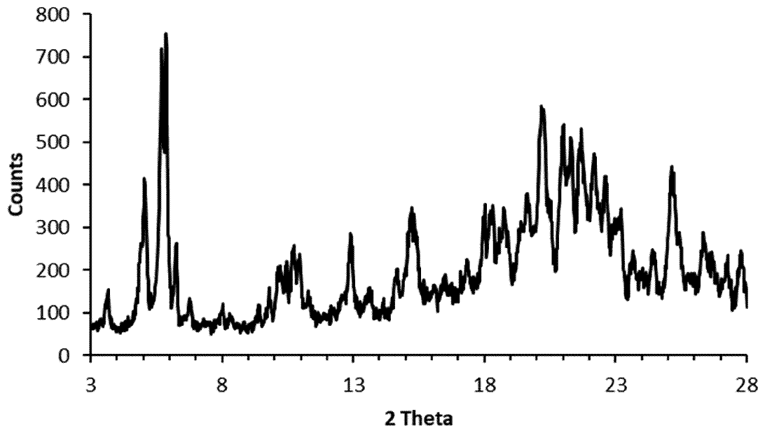

In the X-ray diffraction diagrams of FIG. 1 the angle of refraction 2theta (20) is plotted on the horizontal axis and the counts on the vertical axis.

For avoidance of any doubt, the above-listed peaks describe the experimental results of the X-ray powder diffraction shown in FIG. 1. It is understood that, in contrast to the above peak list, only a selection of characteristic peaks is required to fully and unambiguously characterize COMPOUND-HCl in the respective crystalline form of the present invention.

### DESCRIPTION OF THE INVENTION

In the following the present invention will be described and various embodiments of the invention are presented.

1) In a first embodiment, the present invention relates to a process for the manufacturing of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester (COMPOUND), or of a hydrochloride salt thereof (COMPOUND-HCl)

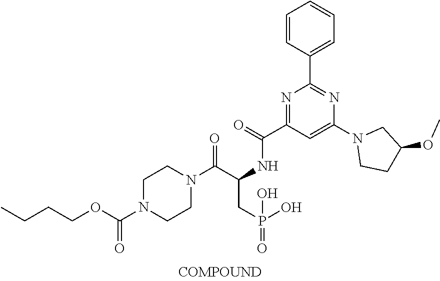 [SMILES: CCCCOC(=O)N1CCN(C(=O)[C@H](CP(=O)(O)O)NC(=O)c2cc(N3CC[C@H](OC)C3)nc(-c3ccccc3)n2)CC1]

said process comprising the reaction of a compound of formula (I)

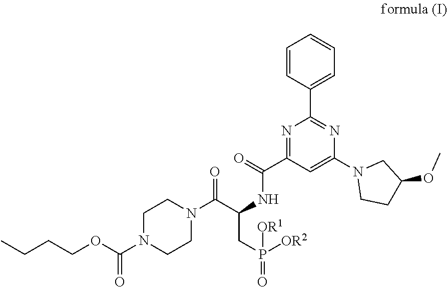

wherein R¹ and R² represent independently from each other (C₁₋₄)alkyl,
with hydrochloride in a mixture comprising an organic solvent and water,
wherein the organic solvent is acetone, toluene, R³C(O)OR⁴ or any mixture thereof, wherein
R³ represents hydrogen or (C₁₋₂)alkyl and R⁴ represents hydrogen or (C₁₋₃)alkyl;
and wherein the amount of water is less than 12 equivalents relative to the amount of compound of formula (I).

Definitions provided herein are intended to apply uniformly throughout the description and the claims unless an otherwise expressly set out definition provides a broader or narrower definition. It is well understood that a definition or preferred definition of a term defines and may replace the respective term independently of (and in combination with) any definition or preferred definition of any or all other terms as defined herein.

It is to be understood that the hydrochloride that is required in the reaction might originate from any appropriate source of hydrochloride that does not increase the amount of water in the reaction mixture to 12 equivalents or more water relative to the amount of compound of formula (I). For instance, the hydrochloride might be added to the reaction mixture as hydrochloride gas or as a solution in a solvent, wherein the solvent is an organic solvent (examples: dioxane, ethanol and isopropanol, especially dioxane), or water (especially a solution in water, and notably a concentrated solution in water); or might be generated in-situ by reaction of an electrophilic chloride source (i.e. a compound that releases chloride in a reaction with a nucleophile) with a protic nucleophile (i.e. a compound comprising a functional group comprising a heteroatom that is attached to a hydrogen atom, wherein the heteroatom has one or more free electron pair(s)). Examples of electrophilic chloride sources are carboxylic acid chlorides (especially (C₁₋₃)alkyl-C(O)Cl and notably CH₃C(O)Cl), SOCl₂, POCl₃, PCl₃, and PCIS; preferred are carboxylic acid chlorides (especially (C₁₋₃)alkyl-C(O)Cl and notably CH₃C(O)Cl). Examples of protic nucleophiles are water, alkanols (especially (C₁₋₄) alkanols and notably ethanol), amines (especially (C₁₋₃)alkyl-NH₂ and ((C₁₋₃)alkyl)₂-NH) and thiols (especially (C₁₋₄)alkyl-SH); preferred are water and alkanols (especially (C₁₋₄)alkanols and notably ethanol); most preferred is ethanol. Preferred combinations of electrophilic chloride sources and protic nucleophiles are carboxylic acid chlorides and alkanols (especially (C₁₋₃)alkyl-C(O)Cl and (C₁₋₄)alkanols and notably CH₃C(O)Cl and ethanol). It is further understood that the reaction of a carboxylic acid anhydride (especially ((C₁₋₃)alkyl-C(O))₂O and notably (CH₃C(O))₂O) with an aqueous solution of hydrochloride in water can be used to generate hydrochloride in the reaction mixture with a low water content (such as a water content of less than 12 equivalents). The term “in-situ” in the context of “generated in-situ by reaction of an electrophilic chloride source and a protic nucleophile” means that the hydrochloride is generated in the reaction mixture by either adding the electrophilic chloride source to the reaction mixture comprising the protic nucleophile or by adding the protic nucleophile to the reaction mixture comprising the electrophilic chloride source.

The phrase “wherein the organic solvent is acetone, toluene, R³C(O)OR⁴ or any mixture thereof”, means that the organic solvent is acetone, toluene, R³C(O)OR⁴, a mixture of more than one (especially two or three and notably two) different R³C(O)OR⁴ (wherein the R³C(O)OR⁴ differ in either R³, R⁴, or both R³ and R⁴) or any mixture of acetone, toluene and one or more (especially one, two or three and notably one or two) R³C(O)OR⁴ (wherein the R³C(O)OR⁴ differ, if applicable, in either R³, R⁴, or both R³ and R⁴). In case the organic solvent is a mixture, it is preferred that the organic solvent is a mixture of more than one (especially two or three and notably two) different R³C(O)OR⁴ (wherein the R³C(O)OR⁴ differ in either R³, R⁴, or both R³ and R⁴). Preferred organic solvents are R³C(O)OR⁴ and a mixture of two different R³C(O)OR⁴ (wherein the R³C(O)OR⁴ differ in either R³, R⁴, or both R³ and R⁴); more preferred are CH₃C(O)OH and a mixture of CH₃C(O)OH and CH₃C(O)OEt; most preferred is CH₃C(O)OH (acetic acid).

The term “equivalents”, as used in the context of “the amount of a first compound is “X” equivalents relative to the amount of a second compound”, means that a given mixture contains “X” times the amount (in any unity related to the number of molecules) of a first compound relative to the amount of a second compound (given in the same unity). For instance, the term “equivalents” means in the context of “wherein the amount of water is less than 12 (or, alternatively, is between a value “x” and a value “y”) equivalents relative to the amount of compound of formula (I)”, that the reaction mixture contains an amount (in any unity related to the number of molecules) of water in the given range of equivalents relative to the amount of compound of formula (I) (given in the same unity). For instance, if the amount of water in the reaction mixture is defined to be less than 12 equivalents relative to the amount of compound of formula (I), this means that the molar ratio between water and compound of formula (I) in the reaction mixture is below 12 to 1; and if the amount of water in the reaction mixture is defined to be between 0.5 and 3.0 equivalents relative to the amount of compound of formula (I), this means that the molar ratio between water and compound of formula (I) in the reaction mixture is 1 to 2, 3 to 1 or any value in between.

Preferably, the amount of water is between 0.2 and 9.5 equivalents (more preferably between 0.5 and 3.0 equivalents and most preferably between 0.5 and 2.0 equivalents) relative to the amount of compound of formula (I). It is to be understood that the amount of water refers to the total amount of water present in the reaction mixture, i.e. the amount of added water together with the amount of water present in the reagents, solvents, reaction vessels and other sources of water.

Unless used regarding temperatures, the term “about” placed before a numerical value “X” refers in the current application to an interval extending from X minus 10% of X to X plus 10% of X, especially to an interval extending from X minus 5% of X to X plus 5% of X and notably to an interval extending from X minus 2% of X to X plus 2% of X. In the particular case of temperatures, the term “about” placed before a temperature “Y” refers in the current application to an interval extending from the temperature Y minus 10° C. to Y plus 10° C., especially to an interval extending from Y minus 5° C. to Y plus 5° C., and notably to an interval extending from Y minus 3° C. to Y plus 3° C. Room temperature means a temperature of about 25° C.

Whenever the word “between” or “to” is used to describe a numerical range, it is to be understood that the end points of the indicated range are explicitly included in the range. For example: if a temperature range is described to be between 40° C. and 80° C. (or 40° C. to 80° C.), this means that the end points 40° C. and 80° C. are included in the range; or if a variable is defined as being an integer between 1 and 4 (or 1 to 4), this means that the variable is the integer 1, 2, 3, or 4.

The expression % w/w refers to a percentage by weight compared to the total weight of the composition considered. Likewise, the expression v/v refers to a ratio by volume of the two components considered.

The term “alkyl”, used alone or in combination, refers to a straight or branched saturated hydrocarbon chain containing one to four carbon atoms. The term “(Cy)alkyl” (x and y each being an integer), refers to an alkyl group as defined before containing x to y carbon atoms.

For example a (C₁₋₄)alkyl group contains from one to four carbon atoms. Examples of (C₁₋₄)alkyl groups are methyl, ethyl, n-propyl, iso-propyl, n-butyl, iso-butyl, sec-butyl and tert-butyl. Examples of (C₁₋₃)alkyl groups are methyl, ethyl, n-propyl and iso-propyl. Examples of (C₂)alkyl groups are methyl and ethyl. In case “R¹” represents a “(C₄)alkyl” group, the term “(C₁₋₄)alkyl” means methyl, ethyl, n-propyl, iso-propyl, n-butyl, iso-butyl, sec-butyl and tert-butyl, preferably methyl, ethyl, n-propyl and iso-propyl and most preferably ethyl. In case “R²” represents a “(C₁₋₄)alkyl” group, the term “(C₁₋₄)alkyl” means methyl, ethyl, n-propyl, iso-propyl, n-butyl, iso-butyl, sec-butyl and tert-butyl, preferably methyl, ethyl, n-propyl and iso-propyl and most preferably ethyl. In case “R³” represents a “(C₁₋₂)alkyl” group, the term “(C₁₋₂)alkyl” means methyl and ethyl, preferably methyl. In case “R⁴” represents a “(C₁₋₃)alkyl” group, the term “(C₁₋₃)alkyl” means methyl, ethyl, n-propyl and iso-propyl, preferably methyl and ethyl and most preferably ethyl.

The term “(C₁₋₃)alkyl-C(O)Cl”, used alone or in combination, refers to an alkyl group as defined before containing from one to three carbon atoms which is attached via a carbon atom to a —C(O)Cl group. Examples of said groups are acetyl chloride (CH₃C(O)Cl), propionyl chloride (CH₃CH₂C(O)Cl), butyryl chloride (CH₃CH₂CH₂C(O)Cl) and isobutyryl chloride (CH₃)₂CHC(O)Cl). Preferred are acetyl chloride (CH₃C(O)Cl) and propionyl chloride (CH₃CH₂C(O)Cl) and most preferred is acetyl chloride (CH₃C(O)Cl).

The term “((C₁₋₃)alkyl-C(O))₂O”, used alone or in combination, refers to water (H₂O) wherein both hydrogen atoms have been independently replaced with (C₁₋₃)alkyl-carbonyl-groups ((C₁₋₃)alkyl-C(O)—), wherein the (C₁₋₃)alkyl-groups are as defined before. Examples of ((C₁₋₃) alkyl-C(O))₂O groups are acetic anhydride, propionic anhydride, butyric anhydride and isobutyric anhydride. Preferred is acetic anhydride.

The term “(C₁₋₄)alkanol”, used alone or in combination, refers to a straight or branched alkane containing one to four carbon atoms, wherein one hydrogen atom has been replaced with hydroxy. Examples of said groups are methanol, ethanol, propanol, isopropanol, butanol, isobutanol, sec-butanol and tert-butanol. Preferred are methanol, ethanol and isopropanol and most preferred is ethanol.

The term “(C₁₋₄)alkyl-SH”, used alone or in combination, refers to a straight or branched alkane containing one to four carbon atoms, wherein one hydrogen atom has been replaced with a sulfanyl group (—SH). Examples of said groups are methanethiol, ethanethiol, propanethiol, isopropanethiol, butanethiol, isobutanethiol, sec-butanethiol and tert-butanethiol.

The term “(C₁₋₃)alkyl-NH₂”, used alone or in combination, refers to ammonia (NH₃) wherein one hydrogen atom has been replaced with a (C₁₋₃)alkyl group as defined before. Examples of said groups are methylamino, ethylamino, n-propylamino, and iso-propylamino.

The term “((C₁₋₃)alkyl)₂-NH”, used alone or in combination, refers to ammonia (NH₃) wherein two hydrogen atoms have been independently replaced with (C₁₋₃)alkyl groups as defined before, wherein the two alkyl groups may be the same or different. Examples of said groups are dimethylamino, methyl-ethylamino, methyl-n-propylamino, methyl-iso-propylamino, diethylamino, ethyl-n-propylamino, ethyl-iso-propylamino, di-n-propylamino, n-propyl-iso-propylamino, and di-iso-propylamino.

2) A further embodiment refers to a process according to embodiment 1), wherein the process is a process for the manufacturing of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride (COMPOUND-HCl).

3) A further embodiment refers to a process according to any one of embodiments 1) or 2), wherein R¹ represents methyl, ethyl, n-propyl, or iso-propyl.

4) A further embodiment refers to a process according to any one of embodiments 1) to 3), wherein R² represents methyl, ethyl, n-propyl, or iso-propyl.

5) A further embodiment refers to a process according to any one of embodiments 1) or 2), wherein R¹ and R² are identical and represent methyl, ethyl, n-propyl, or iso-propyl.

6) A further embodiment refers to a process according to any one of embodiments 1) or 2), wherein R¹ and R² both represent ethyl.

7) A further embodiment refers to a process according to any one of embodiments 1) to 6), wherein the hydrochloride is added to the reaction mixture as hydrochloride gas or is generated in-situ by reaction of an electrophilic chloride source with a protic nucleophile.

8) A further embodiment refers to a process according to any one of embodiments 1) to 6), wherein the hydrochloride is generated in-situ by reaction of an electrophilic chloride source with a protic nucleophile.

9) A further embodiment refers to a process according to any one of embodiments 7) or 8), wherein the electrophilic chloride source is selected from carboxylic acid chlorides (especially (C₁₋₃)alkyl-C(O)Cl), SOCl₂, POCl₃, PCl₃, and PCIs.

10) A further embodiment refers to a process according to any one of embodiments 7) or 8), wherein the electrophilic chloride source is selected from (C₁₋₃)alkyl-C(O)Cl.

11) A further embodiment refers to a process according to any one of embodiments 7) or 8), wherein the electrophilic chloride source is acetyl chloride (CH₃C(O)Cl).

12) A further embodiment refers to a process according to any one of embodiments 7) to 11), wherein the protic nucleophile is selected from water, alkanols (especially (C₁₋₄)alkanols), amines (especially (C₁₋₃)alkyl-NH₂) and thiols (especially (C₁₋₄)alkyl-SH).

13) A further embodiment refers to a process according to any one of embodiments 7) to 11), wherein the protic nucleophile is selected from water and (C₁₋₄)alkanol (especially ethanol).

14) A further embodiment refers to a process according to any one of embodiments 7) to 11), wherein the protic nucleophile is selected from (C₁₋₄)alkanol (especially ethanol).

15) A further embodiment refers to a process according to any one of embodiments 7) or 8), wherein the hydrochloride is generated in-situ by reaction of an electrophilic chloride source selected from (C₁₋₃)alkyl-C(O)Cl with a protic nucleophile selected from water and (C₁₋₄)alkanol (especially (C₁₋₄)alkanol).

16) A further embodiment refers to a process according to any one of embodiments 7) or 8), wherein the hydrochloride is generated in-situ by reaction of acetyl chloride (CH₃C(O)Cl) with ethanol.

17) A further embodiment refers to a process according to any one of embodiments 7) to 16), wherein the amount of the electrophilic chloride source (especially (C₁₋₃)alkyl-C(O)Cl, and notably CH₃C(O)Cl) is between 0.5 and 20 equivalents relative to the amount of compound of formula (I). Lower limits of the electrophilic chloride source are 0.5, 0.8, 0.9, and 1.0 equivalents, upper limits are 20, 10, 5.0, 3.0, and 2.0 equivalents. It is to be understood that each lower limit can be combined with each upper limit. Hence all combinations shall herewith be disclosed.

18) A further embodiment refers to a process according to any one of embodiments 7) to 16), wherein the amount of the electrophilic chloride source (especially (C₁₋₃)alkyl-C(O)Cl, and notably CH₃C(O)Cl) is between 0.9 and 5.0 equivalents (especially between 1.0 and 3.0 equivalents) relative to the amount of compound of formula (I).

19) A further embodiment refers to a process according to any one of embodiments 7) to 16), wherein the amount of the electrophilic chloride source (especially (C₁₋₃)alkyl-C(O)Cl, and notably CH₃C(O)Cl) is between 1.0 and 2.0 equivalents (especially about 1.5 equivalents) relative to the amount of compound of formula (I).

20) A further embodiment refers to a process according to any one of embodiments 7) to 19), wherein the amount of the protic nucleophile (especially water and (C₁₋₄)alkanol, and notably ethanol) is between 1.0 and 10 equivalents relative to the amount of the electrophilic chloride source. Lower limits of the protic nucleophile are 1.0, 1.2, 1.4, and 1.5 equivalents, upper limits are 10, 5.0, 2.5, and 2.0 equivalents. It is to be understood that each lower limit can be combined with each upper limit. Hence all combinations shall herewith be disclosed.

21) A further embodiment refers to a process according to any one of embodiments 7) to 19), wherein the amount of the protic nucleophile (especially water and (C₁₋₄)alkanol, and notably ethanol) is between 1.2 and 5.0 equivalents (especially between 1.4 and 2.5 equivalents) relative to the amount of the electrophilic chloride source.

22) A further embodiment refers to a process according to any one of embodiments 7) to 19), wherein the amount of the protic nucleophile (especially water and (C₁₋₄)alkanol, and notably ethanol) is between 1.5 and 2.0 equivalents (especially about 1.67 equivalents) relative to the amount of the electrophilic chloride source.

23) A further embodiment refers to a process according to any one of embodiments 1) to 6), wherein the hydrochloride is generated in-situ by reaction of ((C₁₋₃)alkyl-C(O))₂O (especially acetic anhydride) with an aqueous solution of hydrochloride in water.

24) A further embodiment refers to a process according to embodiment 7), wherein the hydrochloride is added to the reaction mixture as hydrochloride gas.

25) A further embodiment refers to a process according to any one of embodiments 1) to 16), 23) or 24), wherein the amount of hydrochloride that is added to the reaction mixture as hydrochloride gas; or that is generated in-situ by reaction of an electrophilic chloride source with a protic nucleophile; or that is generated in-situ by reaction of ((C₁₋₃)alkyl-C(O))₂O with an aqueous solution of hydrochloride in water, is between 0.5 and 20 equivalents relative to the amount of compound of formula (I). Lower limits of the amount of hydrochloride are 0.5, 0.8, 0.9, and 1.0 equivalents, upper limits are 20, 10, 5.0, 3.0, and 2.0 equivalents. It is to be understood that each lower limit can be combined with each upper limit. Hence all combinations shall herewith be disclosed.

26) A further embodiment refers to a process according to any one of embodiments 1) to 16) or 24), wherein the amount of hydrochloride that is added to the reaction mixture as hydrochloride gas; or that is generated in-situ by reaction of an electrophilic chloride source with a protic nucleophile, is between 0.9 and 5.0 equivalents (especially between 1.0 and 3.0 equivalents) relative to the amount of compound of formula (I).

27) A further embodiment refers to a process according to any one of embodiments 1) to 16) or 24), wherein the amount of hydrochloride that is added to the reaction mixture as hydrochloride gas; or that is generated in-situ by reaction of an electrophilic chloride source with a protic nucleophile, is between 1.0 and 2.0 equivalents (especially about 1.5 equivalents) relative to the amount of compound of formula (I).

28) A further embodiment refers to a process according to any one of embodiments 1) to 27), wherein the organic solvent is toluene, R³C(O)OR⁴ or any mixture thereof, wherein R³ represents hydrogen or (C₁₋₂)alkyl and R⁴ represents hydrogen or (C₁₋₃)alkyl.

29) A further embodiment refers to a process according to any one of embodiments 1) to 27), wherein the organic solvent is R³C(O)OR⁴ or any mixture thereof, wherein R³ represents hydrogen or (C₁₋₂)alkyl and R⁴ represents hydrogen or (C₁₋₃)alkyl.

30) A further embodiment refers to a process according to any one of embodiments 1) to 29), wherein R³ represents hydrogen or methyl (especially methyl).

31) A further embodiment refers to a process according to any one of embodiments 1) to 30), wherein R⁴ represents hydrogen, methyl, or ethyl (especially hydrogen).

32) A further embodiment refers to a process according to any one of embodiments 1) to 27), wherein the organic solvent is acetic acid (CH₃C(O)OH), methyl acetate (CH₃C(O)OMe) or ethyl acetate (CH₃C(O)OEt) or any mixture thereof.

33) A further embodiment refers to a process according to any one of embodiments 1) to 27), wherein the organic solvent is acetic acid (CH₃C(O)OH).

34) A further embodiment refers to a process according to any one of embodiments 1) to 33), wherein the volume of the organic solvent is between 1.5 and 20 liter per kilogram of compound of formula (I). Lower limits of the volume of the organic solvent are 1.5, 2.0, 2.5 and 2.8 liter per kilogram of compound of formula (I), upper limits are 20, 10, 5.0, and 3.3 liter per kilogram of compound of formula (I). It is to be understood that each lower limit can be combined with each upper limit. Hence all combinations shall herewith be disclosed.

35) A further embodiment refers to a process according to any one of embodiments 1) to 33), wherein the volume of the organic solvent is between 2.0 and 10 (especially between 2.5 and 5.0) liter per kilogram of compound of formula (I).

36) A further embodiment refers to a process according to any one of embodiments 1) to 33), wherein the volume of the organic solvent is between 2.5 and 3.3 (especially about 2.9) liter per kilogram of compound of formula (I).

37) A further embodiment refers to a process according to any one of embodiments 1) to 33), wherein the concentration of the compound of formula (I) in the organic solvent is between 20 and 30% w/w (especially about 25% w/w).

38) A further embodiment refers to a process according to any one of embodiments 1) to 37), wherein the amount of water is between 0.2 and 9.5 equivalents relative to the amount of compound of formula (I). Lower limits of the amount of water are 0.2, 0.3, 0.5, and 0.8 equivalents, upper limits are 9.5, 5.0, 3.0, and 2.0 equivalents. It is to be understood that each lower limit can be combined with each upper limit. Hence all combinations shall herewith be disclosed.

39) A further embodiment refers to a process according to any one of embodiments 1) to 37), wherein the amount of water is between 0.3 and 5.0 (especially between 0.5 and 3.0) equivalents relative to the amount of compound of formula (I).

40) A further embodiment refers to a process according to any one of embodiments 1) to 37), wherein the amount of water is between 0.5 and 2.0 (especially between 0.8 and 2.0) equivalents relative to the amount of compound of formula (I).

41) A further embodiment refers to a process according to any one of embodiments 1) or 2), said process comprising the reaction of a compound of formula (I)

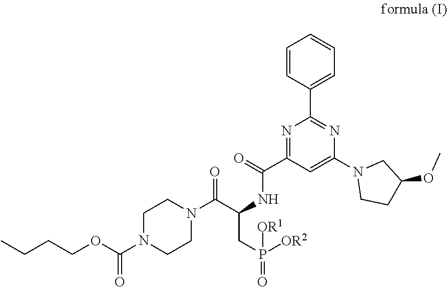

wherein R¹ and R² are identical and represent methyl or ethyl,
with hydrochloride in a mixture comprising an organic solvent and water,
wherein the hydrochloride is added to the reaction mixture as hydrochloride gas in an amount of between 1.0 and 3.0 (especially between 1.0 and 2.0) equivalents relative to the amount of compound of formula (I);
wherein the organic solvent is acetic acid, methyl acetate (CH₃C(O)OMe) or ethyl acetate (CH₃C(O)OEt) or any mixture thereof (especially acetic acid), wherein the concentration of the compound of formula (I) in the organic solvent is between 10 and 40% w/w (especially between 20 and 30% w/w); and
wherein the amount of water is between 0.3 and 5.0 (especially between 0.5 and 3.0) equivalents relative to the amount of compound of formula (I).

42) A further embodiment refers to a process according to any one of embodiments 1) or 2), said process comprising the reaction of a compound of formula (I)

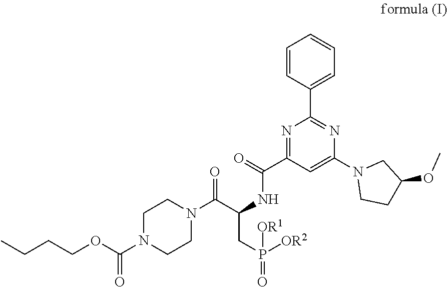

wherein R¹ and R² are identical and represent methyl or ethyl,
with hydrochloride in a mixture comprising an organic solvent and water,
wherein the hydrochloride is generated in-situ by reaction of (C₁₋₃)alkyl-C(O)Cl (especially CH₃C(O)Cl) and (C₁₋₄)alkanol (especially ethanol) and wherein the amount of hydrochloride that is generated in-situ is between 1.0 and 3.0 (especially between 1.0 and 2.0) equivalents relative to the amount of compound of formula (I);
wherein the organic solvent is acetic acid, methyl acetate (CH₃C(O)OMe) or ethyl acetate (CH₃C(O)OEt) or any mixture thereof (especially acetic acid), wherein the concentration of the compound of formula (I) in the organic solvent is between 10 and 40% w/w (especially between 20 and 30% w/w); and
wherein the amount of water is between 0.3 and 5.0 (especially between 0.5 and 3.0) equivalents relative to the amount of compound of formula (I).

43) A further embodiment refers to a process according to any one of embodiments 41) or 42), wherein R¹ and R² are identical and represent ethyl.

44) A further embodiment refers to a process according to any one of embodiments 41) to 43), wherein the organic solvent is acetic acid, and wherein the concentration of the compound of formula (I) in the organic solvent is between 20 and 30% w/w.

45) A further embodiment refers to a process according to any one of embodiments 41) to 44), wherein the concentration of the compound of formula (I) in the organic solvent is about 25% w/w.

46) A further embodiment refers to a process according to any one of embodiments 41) to 45), wherein the amount of water is between 0.8 and 2.0 equivalents relative to the amount of compound of formula (I).

47) A further embodiment refers to a process according to any one of embodiments 1) to 46), wherein the reaction is performed at a temperature between 20° C. and 40° C. Lower limits of the reaction temperature are 20° C., 23° C., 25° C., and 27° C., upper limits are 40° C., 37° C., 35° C., and 33° C. It is to be understood that each lower limit can be combined with each upper limit. Hence all combinations shall herewith be disclosed.

48) A further embodiment refers to a process according to any one of embodiments 1) to 46), wherein the reaction is performed at a temperature between 25° C. and 35° C. (especially between 27° C. and 33° C.).

49) A further embodiment refers to a process according to any one of embodiments 1) to 48), wherein the reaction mixture is treated after being stirred for a stirring time of at least 3 hours (especially for about 4 hours) with seeding crystals of COMPOUND-HCl.

The term “stirring time” means the time after the last reagent/reactant has been added to the reaction mixture until the time the seeding crystals are added. Preferably, the stirring time is between 3 hours and 8 hours, more preferably between 3.5 hours and 5 hours and most preferably about 4 hours.

Preferably the seeding crystals of COMPOUND-HCl are in crystalline form 2 as described in WO 2018/055016 or in crystalline form (I) as described herein.

50) A further embodiment refers to a process according to embodiments 49), wherein the seeding crystals of COMPOUND-HCl are in crystalline form 2 as described in WO 2018/055016.

Seeding crystals in crystalline form 2 may be obtained for instance from the process described in WO 2018/055016 or from the process described herein.

Seeding crystals may also be obtained by internal seeding, i.e. by removing a sample from the reaction mixture, adding an anti-solvent (especially ethyl acetate) to the sample and re-adding the obtained suspension to the reaction mixture. Preferably 2.0 to 4.0 mL (most preferably about 2.5 mL) ethyl acetate per gramm sample are added to the sample.

51) A further embodiment refers to a process according to any one of embodiments 49) or 50), wherein the amount of seeding crystals is between 0.1% w/w and 2.0% w/w relative to the amount of compound of formula (I). Lower limits of the amount of seeding crystals are 0.1, 0.2, and 0.3% w/w, upper limits are 2.0, 1.0, and 0.6% w/w. It is to be understood that each lower limit can be combined with each upper limit. Hence all combinations shall herewith be disclosed.

52) A further embodiment refers to a process according to any one of embodiments 49) or 50), wherein the amount of seeding crystals is between 0.1% w/w and 1.0% w/w (especially between 0.1% w/w and 0.6% w/w) relative to the amount of compound of formula (I).

53) A further embodiment refers to a process according to any one of embodiments 49) or 50), wherein the amount of seeding crystals is between 0.2% w/w and 0.6% w/w relative to the amount of compound of formula (I).

54) A further embodiment refers to a process according to any one of embodiments 1) to 53), wherein an anti-solvent is added to the reaction mixture, wherein the anti-solvent is selected from toluene, acetone, ethyl acetate (especially acetone or ethyl acetate) or any mixture thereof.

55) A further embodiment refers to a process according to embodiment 54), wherein the anti-solvent is ethyl acetate.

56) A further embodiment refers to a process according to any one of embodiments 54) or 55), wherein the volume of the added anti-solvent (especially ethyl acetate) is between 3.0 and 15 liter per kilogram of compound of formula (I). Lower limits of the volume of the anti-solvent are 3.0, 3.5, 4.0 and 4.5 liter per kilogram of compound of formula (I), upper limits are 15, 10, 7.0, and 6.0 liter per kilogram of compound of formula (I). It is to be understood that each lower limit can be combined with each upper limit. Hence all combinations shall herewith be disclosed.

57) A further embodiment refers to a process according to any one of embodiments 54) or 55), wherein the volume of the added anti-solvent (especially ethyl acetate) is between 3.5 and 7.0 liter per kilogram of compound of formula (I).

58) A further embodiment refers to a process according to any one of embodiments 54) or 55), wherein the volume of the added ethyl acetate (anti-solvent) is between 4.0 and 6.0 (especially about 5.0) liter per kilogram of compound of formula (I).

59) A further embodiment refers to a process according to any one of embodiments 1) to 58), wherein the anti-solvent is added within 1 hour to 5 hours (especially within 1.5 hours to 3 hours) to the reaction mixture.

60) A further embodiment refers to a process according to any one of embodiments 1) to 59), wherein the obtained precipitate is filtered and dried (or filtered, washed with anti-solvent (especially ethyl acetate) and dried) to give COMPOUND-HCl in solid form (hereinafter also referred to as “PRECIPITATED COMPOUND-HCl”).

The reaction of compound of formula (I) with acetyl chloride (CH₃C(O)Cl, about 1.5 equivalents) and ethanol (about 2.5 equivalents) in acetic acid (about 3 vol) and in the presence of water (about 2 equivalents) at about 30° C. gives after stirring, seeding with COMPOUND-HCl in crystalline form 2 (as described in WO 2018/055016), treating with ethyl acetate (about 5 vol), filtering, washing with ethyl acetate and drying COMPOUND-HCl in crystalline form (I).

61) A further embodiment refers to a process according to any one of embodiments 1) to 60), wherein the process further comprises the step of recrystallizing PRECIPITATED COMPOUND-HCl (especially COMPOUND-HCl in crystalline form (I)) from a mixture of acetone and water.

62) A further embodiment refers to a process according to embodiment 61), wherein the PRECIPITATED COMPOUND-HCl (especially COMPOUND-HCl in crystalline form (I)) is dissolved in a volume between 3.0 and 25 liter of the mixture of acetone and water per kilogram of PRECIPITATED COMPOUND-HCl at a temperature between 35° C. and 65° C. Lower limits of the volume of the acetone/water mixture are 3.0, 3.2, 3.4 and 3.5 liter per kilogram of PRECIPITATED COMPOUND-HCl, upper limits are 25, 10, 7.0, and 5.0 liter per kilogram of PRECIPITATED COMPOUND-HCl. It is to be understood that each lower limit can be combined with each upper limit. Hence all combinations shall herewith be disclosed. Lower limits of the temperature are 35° C., 40° C. and 45° C., upper limits are 65° C., 60° C. and 55° C. It is to be understood that each lower limit can be combined with each upper limit. Hence all combinations shall herewith be disclosed.

Preferably, the PRECIPITATED COMPOUND-HCl (especially COMPOUND-HCl in crystalline form (I)) is added to a mixture of acetone and water that is pre-warmed to the respective temperature (such as a temperature between 35° C. and 65° C.).

63) A further embodiment refers to a process according to embodiment 62), wherein the volume of the mixture of acetone and water is between 3.2 and 7.0 liter per kilogram of PRECIPITATED COMPOUND-HCl (especially COMPOUND-HCl in crystalline form (I)).

64) A further embodiment refers to a process according to embodiment 62), wherein the volume of the mixture of acetone and water is between 3.4 and 5.0 (especially 3.5±0.1) liter per kilogram of PRECIPITATED COMPOUND-HCl (especially COMPOUND-HCl in crystalline form (I)).

65) A further embodiment refers to a process according to any one of embodiments 62) to 64), wherein the temperature is between 40° C. and 60° C.

66) A further embodiment refers to a process according to any one of embodiments 62) to 64), wherein the temperature is between 45° C. and 55° C. (especially 50° C.±2° C.).

67) A further embodiment refers to a process according to any one of embodiments 61) to 66), wherein the ratio between acetone and water is between 2:1 v/v and 20:1 v/v. Lower limits of the ratio between acetone and water are 2:1 v/v, 5:2 v/v, 3:1 v/v and 7:2 v/v, upper limits are 20:1 v/v, 10:1 v/v, 7:1 v/v and 5:1 v/v. It is to be understood that each lower limit can be combined with each upper limit. Hence all combinations shall herewith be disclosed.

67) A further embodiment refers to a process according to any one of embodiments 61) to 66), wherein the ratio between acetone and water is between 3:1 v/v and 7:1 v/v.

68) A further embodiment refers to a process according to any one of embodiments 61) to 66), wherein the ratio between acetone and water is between 7:2 v/v and 7:1 v/v (especially between 7:2 v/v and 5:1 v/v).

69) A further embodiment refers to a process according to any one of embodiments 61) to 68), wherein the solution of PRECIPITATED COMPOUND-HCl (especially COMPOUND-HCl in crystalline form (I)) in the mixture of acetone and water is diluted with acetone and/or treated with seeding crystals of COMPOUND-HCl at a temperature between 25° C. and 55° C. Lower limits of the temperature are 25° C. and 30° C., upper limits are 55° C., 45° C. and 35° C. It is to be understood that each lower limit can be combined with each upper limit. Hence all combinations shall herewith be disclosed.

It is to be understood that, in case the solution is diluted with acetone and treated with seeding crystals, the seeding crystals might be added before dilution of the solution with acetone or that the solution might be diluted with acetone before seeding crystals are added. Preferably the seeding crystals are added before dilution with acetone.

70) A further embodiment refers to a process according to embodiment 69), wherein the temperature of the solution of PRECIPITATED COMPOUND-HCl (especially COMPOUND-HCl in crystalline form (I)) during the dilution with acetone and/or the treatment with seeding crystals of COMPOUND-HCl is between 25° C. and 35° C. (especially 30° C.±2° C.).

71) A further embodiment refers to a process according to any one of embodiments 69) or 70), wherein the solution of PRECIPITATED COMPOUND-HCl (especially COMPOUND-HCl in crystalline form (I)) in the mixture of acetone and water is diluted with acetone and treated with seeding crystals of COMPOUND-HCl.

72) A further embodiment refers to a process according to any one of embodiments 69) to 71), wherein the solution of PRECIPITATED COMPOUND-HCl (especially COMPOUND-HCl in crystalline form (I)) in the mixture of acetone and water is first diluted with acetone and subsequently treated with seeding crystals of COMPOUND-HCl.

73) A further embodiment refers to a process according to any one of embodiments 69) to 71), wherein the solution of PRECIPITATED COMPOUND-HCl (especially COMPOUND-HCl in crystalline form (I)) in the mixture of acetone and water is first treated with seeding crystals of COMPOUND-HCl and subsequently diluted with acetone.

74) A further embodiment refers to a process according to any one of embodiments 69) to 73), wherein the solution of PRECIPITATED COMPOUND-HCl (especially COMPOUND-HCl in crystalline form (I)) in the mixture of acetone and water is diluted with acetone in an amount of between 6.0 and 20 liter per kilogram of PRECIPITATED COMPOUND-HCl. Lower limits of the amount of the acetone are 6.0, 8.0 and 10 liter per kilogram of PRECIPITATED COMPOUND-HCl, upper limits are 20, 17 and 14 liter per kilogram of PRECIPITATED COMPOUND-HCl. It is to be understood that each lower limit can be combined with each upper limit. Hence all combinations shall herewith be disclosed.

75) A further embodiment refers to a process according to any one of embodiments 69) to 73), wherein the solution of PRECIPITATED COMPOUND-HCl (especially COMPOUND-HCl in crystalline form (I)) in the mixture of acetone and water is diluted with acetone in an amount of between 8.0 and 17 (especially between 10 and 14) liter per kilogram of PRECIPITATED COMPOUND-HCl.

76) A further embodiment refers to a process according to any one of embodiments 69) to 75), wherein the total volume of acetone (i.e. the volume of acetone in the acetone/water mixture used for dissolution of PRECIPITATED COMPOUND-HCl together with the volume of acetone used for dilution of the solution of PRECIPITATED COMPOUND-HCl in the mixture of acetone and water) is between 12 and 35 liter per kilogram of PRECIPITATED COMPOUND-HCl (especially COMPOUND-HCl in crystalline form (I)). Lower limits of the total volume of acetone are 12, 13.5 and 15 liter per kilogram of PRECIPITATED COMPOUND-HCl, upper limits are 35, 25, 20 and 17 liter per kilogram of PRECIPITATED COMPOUND-HCl. It is to be understood that each lower limit can be combined with each upper limit. Hence all combinations shall herewith be disclosed.

77) A further embodiment refers to a process according to any one of embodiments 69) to 75), wherein the total volume of acetone is between 13.5 and 20 (especially between 15 and 20) liter per kilogram of PRECIPITATED COMPOUND-HCl (especially COMPOUND-HCl in crystalline form (I)).

78) A further embodiment refers to a process according to any one of embodiments 69) to 75), wherein the total volume of acetone is between 15 and 17 liter per kilogram of PRECIPITATED COMPOUND-HCl (especially COMPOUND-HCl in crystalline form (I)).

79) A further embodiment refers to a process according to any one of embodiments 69) to 78), wherein the dilution of the solution of PRECIPITATED COMPOUND-HCl (especially COMPOUND-HCl in crystalline form (I)) in the mixture of acetone and water is performed within 1 hour to 10 hours (especially within 3 hours to 6 hours and notably between 3 hours to 4 hours).

80) A further embodiment refers to a process according to any one of embodiments 69) to 79), wherein the seeding crystals of COMPOUND-HCl are in the crystalline form 2 of COMPOUND-HCl as described in WO 2018/055016.

81) A further embodiment refers to a process according to any one of embodiments 69) to 80), wherein the amount of the seeding crystals of COMPOUND-HCl (especially of COMPOUND-HCl in the crystalline form 2 as described in WO 2018/055016) is between 0.05% w/w and 5.0% w/w relative to the amount of PRECIPITATED COMPOUND-HCl (especially COMPOUND-HCl in crystalline form (I)). Lower limits of the amount of seeding crystals are 0.05, 0.1, 0.2 and 0.4% w/w, upper limits are 5.0, 2.0, 1.0 and 0.6% w/w. It is to be understood that each lower limit can be combined with each upper limit. Hence all combinations shall herewith be disclosed.

Seeding crystals in crystalline form 2 may be obtained for instance from the process described in WO 2018/055016 or from the process described herein. Seeding crystals may also be obtained by internal seeding, i.e. by removing a sample from the solution of PRECIPITATED COMPOUND-HCl (especially COMPOUND-HCl in crystalline form (I)) in the mixture of acetone and water, adding the solution to acetone and re-adding the obtained suspension to the solution of PRECIPITATED COMPOUND-HCl in the mixture of acetone and water. Preferably 5 to 40 mL (more preferably 10 to 20 mL and most preferably about 15 mL) acetone per milliliter sample are used for the internal seeding at RT.

82) A further embodiment refers to a process according to embodiment 81), wherein the amount of the seeding crystals is between 0.1% w/w and 2.0% w/w (especially between 0.4% w/w and 2.0% w/w) relative to the amount of PRECIPITATED COMPOUND-HCl (especially COMPOUND-HCl in crystalline form (I)).

83) A further embodiment refers to a process according to embodiment 81), wherein the amount of the seeding crystals is between 0.2% w/w and 1.0% w/w (especially between 0.4% w/w and 0.6% w/w) relative to the amount of PRECIPITATED COMPOUND-HCl (especially COMPOUND-HCl in crystalline form (I)).

84) A further embodiment refers to a process according to any one of embodiments 61) to 83), wherein the mixture (especially the suspension obtained from the solution of PRECIPITATED COMPOUND-HCl (especially COMPOUND-HCl in crystalline form (I)) in the mixture of acetone and water, after dilution with acetone and/or treatment with seeding crystals of COMPOUND-HCl) is cooled to a temperature between 0° C. and 20° C. (especially between 0° C. and 10° C.) and the precipitate is isolated and optionally washed with acetone. The isolation of the precipitate from the mother liquor may be performed by any means suitable for the separation of solids from liquids, such as filtration (preferred) or centrifugation. The term “optionally”, as used in the context of “the precipitate is isolated and optionally washed with acetone”, means that the step of washing the precipitate with acetone may be present or absent in the process.

85) A further embodiment refers to a process according to embodiment 84), wherein the isolated precipitate is dried in vacuo until the water content in the isolated precipitate is between 4.0% w/w and 8.2% w/w (preferably between 5.0% w/w and 7.0% w/w). The water content may be measured by Karl Fischer titration. The obtained product is COMPOUND-HCl in the crystalline form 2 as described in WO 2018/055016.

86) A further embodiment refers to a process according to any one of embodiments 1) to 85), said process further comprising the reaction of a compound of formula (II)

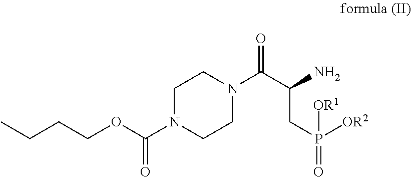

wherein R¹ and R² represent independently from each other (C₁₋₄)alkyl,
with a compound of formula (III)

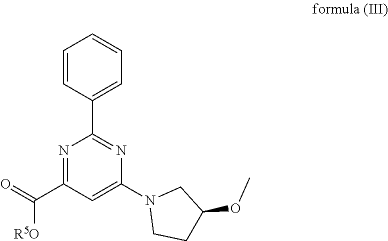

wherein R⁵ represents hydrogen, sodium or potassium (especially sodium), to give a compound of formula (I).

87) A further embodiment refers to a process according to embodiment 86), wherein R¹ and R² both represent ethyl.

88) A further embodiment refers to a process according to any one of embodiments 86) or 87), wherein R⁵ represents sodium.

Preferably, the compound of formula (III) is used as a sodium salt (R⁵ represents sodium) in hydrate form, such as trihydrate form.

89) A further embodiment refers to a process according to any one of embodiments 86) to 88), wherein the reaction is done in the presence of a mixture of EDC and HOBt.

90) A further embodiment refers to a process according to any one of embodiments 86) to 89), wherein the reaction is done in a mixture of solvents selected from two or three of THF, toluene and water (especially THF and water).

91) A further embodiment refers to a process according to any one of embodiments 86) to 90), wherein the reaction is done at a pH value between 4.5 and 6.0 (especially between 4.8 and 5.5).

The compound of formula (III) may be obtained by reaction of a compound of formula (IV) with an aqueous solution of sodium hydroxide in 2-propanol.

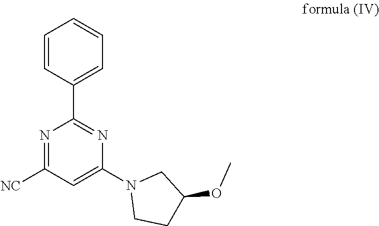 [SMILES: CO[C@H]1CCN(c2cc(C#N)nc(-c3ccccc3)n2)C1]

The reaction may be performed at an elevated temperature (for instance at about 80° C.) and the compound of formula (III) may be isolated by crystallization (for instance by cooling from about 80° C. to about 20° C.). Preferably the reaction mixture may be cooled slowly (at least 4 h) from about 80° C. to about 20° C. to improve filterability of the obtained crystals. For instance, the reaction mixture may be cooled from about 80° C. to about 50° C. in 2 h, kept at about 50° C. for further 30 min and further cooled to about 20° C. within 4 h. The obtained crystals may be washed with toluene and dried.

91) A further embodiment refers to a process according to any one of embodiments 1) to 90), said process further comprising the reaction of a compound of formula (V)

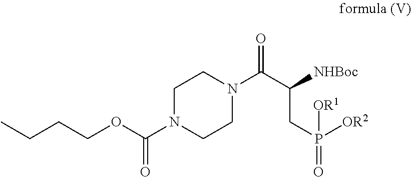

wherein R¹ and R² represent independently from each other (C₁₋₄)alkyl,
with TFA to give a compound of formula (II).

92) A further embodiment refers to a process according to embodiment 91), wherein R¹ and R² both represent ethyl.

93) A further embodiment refers to a process according to any one of embodiments 91) or 92), wherein a solution of a compound of formula (V) in toluene is added to TFA at a temperature between 30° C. and 60° C. Lower limits of the temperature are 30° C., 35° C. and 40° C., upper limits are 60° C., 55° C. and 50° C. It is to be understood that each lower limit can be combined with each upper limit. Hence all combinations shall herewith be disclosed.

94) A further embodiment refers to a process according to any one of embodiments 91) or 92), wherein a solution of a compound of formula (V) in toluene is added to TFA at a temperature between 40° C. and 50° C. (especially about 45° C.).

95) A further embodiment refers to a process according to any one of embodiments 93) or 94), wherein the amount of compound of formula (V) in the solution in toluene is between 50% w/w and 85% w/w. Lower limits of the the amount of compound of formula (V) in the solution in toluene are 50% w/w, 60% w/w and 70% w/w, upper limits are 85% w/w and 80% w/w. It is to be understood that each lower limit can be combined with each upper limit. Hence all combinations shall herewith be disclosed.

96) A further embodiment refers to a process according to any one of embodiments 93) or 94), wherein the amount of compound of formula (V) in the solution in toluene is between 60% w/w and 85% w/w (especially about 70% w/w).

97) A further embodiment refers to a process according to any one of embodiments 91) to 96), wherein the volume of TFA is between 0.5 and 1.5 liter per kilogram of compound of formula (V). Lower limits of the volume of TFA are 0.5, 0.7 and 0.9 liter per kilogram of compound of formula (V), upper limits are 1.5, 1.3 and 1.1 liter per kilogram of compound of formula (V). It is to be understood that each lower limit can be combined with each upper limit. Hence all combinations shall herewith be disclosed.

98) A further embodiment refers to a process according to any one of embodiments 91) to 96), wherein the volume of TFA is between 0.7 and 1.3 (especially about 1.0) liter per kilogram of compound of formula (V).

99) A further embodiment refers to a process according to any one of embodiments 1) to 98), said process further comprising the reaction of a compound of formula (VI)

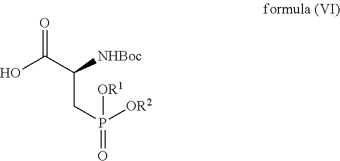

wherein R¹ and R² represent independently from each other (C₁₋₄)alkyl,
with a conmpound of formula (VII)

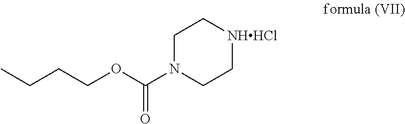

to give a compound of formula (V).

100) A further embodiment refers to a process according to embodiment 99), wherein R¹ and R² both represent ethyl.

101) A further embodiment refers to a process according to any one of embodiments 99) or 100), wherein the reaction is done in the presence of 2,4,6-Tripropyl-1,3,5,2^{λ5},4^{λ5},6^{λ5}-trioxatriphosphinane 2,4,6-trioxide (T3P) or of a mixture of EDC and HOBt.

102) A further embodiment refers to a process according to any one of embodiments 99) to 101), wherein the reaction is done in a solvent selected from ethyl acetate, toluene and a mixture of THF and water.

103) A further embodiment refers to a process according to any one of embodiments 99) or 100), wherein the reaction is done in the presence of 2,4,6-Tripropyl-1,3,5,2^{λ5},4^{λ5},6^{λ5}-trioxatriphosphinane 2,4,6-trioxide (T3P) and in a solvent selected from ethyl acetate and toluene (especially toluene).

104) A further embodiment refers to a process according to any one of embodiments 102) or 103), wherein the volume of the solvent is between 3.5 liter and 7.5 liter (especially about 3.9 liter) per kilogram of compound of formula (VI).

105) A further embodiment refers to a process according to any one of embodiments 99) to 104), wherein a solution of T3P (especially T3P in an amount of about 1.03 equivalents relative to the amount of compound of formula (VI)) in toluene is added to a mixture of compound of formula (VI), compound of formula (VII) (especially compound of formula (VII) in an amount of about 1.03 equivalents relative to the amount of compound of formula (VI)) and triethylamine (especially triethylamine in an amount of about 3.5 equivalents relative to the amount of compound of formula (VI)) in toluene.

106) A further embodiment refers to a process according to any one of embodiments 99) to 105), wherein the reaction is done at a temperature between −5° C. and 25° C. (especially between 10° C. and 20° C.).

107) A further embodiment of the invention relates to crystalline form (I) of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride (COMPOUND-HCl), characterized by the presence of peaks in the X-ray powder diffraction diagram at the following angles of refraction 2θ: 5.7°, 5.9°, and 12.9°.

It is understood that the crystalline form according to embodiment 107) comprises COMPOUND-HCl in form of the hydrochloric acid (hydrochloride) salt. Furthermore, said crystalline form may comprise non-coordinated and/or coordinated solvent (especially non-coordinated and/or coordinated water). Coordinated solvent (especially coordinated water) is used herein as term for a crystalline solvate (especially a crystalline hydrate). For the avoidance of doubt, in this application the term “crystalline hydrate” encompasses non-stoichiometric hydrates. Likewise, non-coordinated solvent is used herein as term for physiosorbed or physically entrapped solvent (definitions according to Polymorphism in the Pharmaceutical Industry (Ed. R. Hilfiker, V C H, 2006), Chapter 8: U. J. Griesser: The Importance of Solvates).

108) Another embodiment relates to a crystalline form of COMPOUND-HCl according to embodiment 107), characterized by the presence of peaks in the X-ray powder diffraction diagram at the following angles of refraction 2θ: 5.1°, 5.7°, 5.9°, 11.0°, and 12.9°.

109) Another embodiment relates to a crystalline form of COMPOUND-HCl according to embodiment 107), characterized by the presence of peaks in the X-ray powder diffraction diagram at the following angles of refraction 2θ: 3.7°, 5.1°, 5.7°, 5.9°, 11.0°, 12.9°, 15.2°, 18.3°, 20.2°, and 21.0°.

110) Another embodiment relates to a crystalline form of COMPOUND-HCl according to embodiment 107), which essentially shows the X-ray powder diffraction pattern as depicted in FIG. 1.

### ABBREVIATIONS AND TERMS USED IN THIS TEXT

### Abbreviations

The following abbreviations are used throughout the specification and the examples:
Ac acetyl
AcCl acetyl chloride
AcOH acetic acid
AcOEt ethyl acetate
AcOMe methyl acetate
aq aqueous
Boc tert-butyloxycarbonyl
dba dibenzylideneacetone
DCM dichloromethane
EDC N-(3-dimethylaminopropyl)-N′-ethyl-carbodiimide hydrochloride
eq. equivalent(s)
Et ethyl
h hour(s)
HOBt hydroxybenzotriazole
HPLC high performance liquid chromatography
IPA 2-propanol
IPAc isopropyl acetate
IPC in process control
JT jacket temperature
M molarity/molar concentration
Me methyl
min minute(s)
NMP 1-methyl-2-pyrrolidinone
NMR nuclear magnetic resonance
org. organic
o.t. of theory
RT room temperature
% a/a percent determined by area ratio
T3P 2,4,6-Tripropyl-1,3,5,2^{λ5},4^{λ5},6^{λ5}-trioxatriphosphinane 2,4,6-trioxide
THF tetrahydrofuran
TFA trifluoroacetic acid
TMSBr trimethylsilyl bromide
vol 1 vol means 1 L solvent per 1 kg reference starting material

### Experimental Part

### X-Ray Powder Diffraction Analysis (XRPD)

X-ray powder diffraction patterns were collected on a Bruker D8 Advance X-ray diffractometer equipped with a Lynxeye detector operated in reflection mode (coupled two Theta/Theta). Typically, the Cu X-ray tube was run at of 40 kV/40 mA. A step size of 0.02° (20) and a step time of 76.8 sec over a scanning range of 3-50° in 20 were applied. The divergence slit was set to fixed sample illumination (variable slit size) and the antiscatter slit was set to 0.3°. Powders were slightly pressed into a silicon single crystal sample holder with depth of 0.5 mm and samples were rotated in their own plane during the measurement. Diffraction data are reported using Cu Kα (λ=1.5418 Å) radiation. The accuracy of the 20 values as provided herein is in the range of +/−0.1-0.2° as it is generally the case for conventionally recorded X-ray powder diffraction patterns.

### High Performance Liquid Chromatography (HPLC)

HPLC system: Agilent 1100/1200/1260 series system with online degasser, low-pressure quaternary pump, autosampler, temperature-controlled column compartment and diode array detector
Flow: 1.0 mL/min
Column temperature: 15° C.
Autosampler temperature: 5±1° C.
Injection volume: 10 μL
Column: Agilent Zorbax SB C18, 150×4.6 mm, 3.5 μm
Wavelength: 263 nm
Solvent A: water/methanol/TFA 95:5:0.5 v/v/v
Solvent B: water/methanol/TFA 5:95:0.5 v/v/v
Gradient:

| Time (min) | % solvent A | % solvent B |
|---|---|---|
| 0.0 | 50 | 50 |
| 30 | 5.0 | 95 |
| 31 | 50 | 50 |
| 35 | 50 | 50 |

Peak table:

| | retention | relative |
|---|---|---|
| | time [min] | retention time |
| COMPOUND•HCl | 16.65 | 1.00 |
| HYDROLYSIS PRODUCT | 4.83 | 0.29 |

### Example 1

### Synthesis of (S)-6-(3-methoxypyrrolidin-1-yl)-2-phenylpyrimidine-4-carbonitrile

A 100 mL Schlenk tube was flushed three times with nitrogen. The tube was charged with NMP (30.0 ml, 1.5 vol) and NMP was degassed in three cycles (vacuum/nitrogen) and Pd₂dba₃ (0.38 g, 0.41 mmol, 0.006 eq.) and 1,1′-Bis(diphenylphosphino)ferrocene (0.57 g, 1.04 mmol, 0.015 eq.) were added and the mixture degassed again in three cycles (vacuum/nitrogen) at JT s 30° C. Subsequently, nitrogen was bubbled through the mixture for 15 min and the solution was then stirred at 20-30° C. for 30 min.

In a 500 mL reactor (S)-4-chloro-6-(3-methoxypyrrolidin-1-yl)-2-phenylpyrimidine (20.0 g, 69.02 mmol, 1.00 eq.), Zn(CN)₂ (4.46 g, 37.96 mmol, 0.55 eq.), toluene (60 mL, 3.0 vol) and NMP (30 ml, 1.5 vol) were charged. The thin slurry was degassed in three cycles (vacuum/nitrogen) at JT s 30° C. Subsequently, nitrogen was bubbled through the mixture for 15 min and the solution was then stirred at 20-30° C. for 30 min. The mixture was warmed to 80-115° C. (target: 110° C.) and the catalyst solution was added over 2 h at 80-115° C. (target: 110° C.). After complete addition the mixture was stirred at 105-115° C. (target: 110° C.) for 30 min.

In a 500 mL reactor toluene (200.0 mL, 10.0 vol), ammonia 25% (44.0 mL, 2.2 vol) and water (100.0 mL, 5.0 vol) were charged and stirred at 30-40° C. and the reaction mixture was added to this emulsion at 30-40° C. After complete addition the emulsion was stirred at 30-40° C. for 30 min and subsequently the phases split for 5 min. The organic phase was then extracted three times with a previously prepared (gas formation during preparation!) solution of N-acetyl-L-cysteine (5.6 g, 34.32 mmol, 0.5 eq.), soda (8.0 g, 66.04 mmol, 0.96 eq.) and water (100.0 ml, 5.0 vol) at 25-35° C. for 30 min and phases split for 5 min. Afterwards the organic phase was twice extracted with water (100.0 mL, 5.0 vol) at 30-35° C. and the phases split for 5 min. The organic phase was then concentrated to 5.0 vol at 40-60° C. under reduced pressure (typical: 150-300 mbar). The distillation was continued at 40-60° C. under reduced pressure (typical: 50-200 mbar) keeping a constant volume by adding IPA (500.0 mL, 25.0 vol). During course of the distillation the product has precipitated. IPA (40.0 mL, 2.0 vol) was added, the slurry warmed to 75-82° C. and post stirred at this temperature for 30 min. The solution was then cooled to 60-70° C. in 60 min and post stirred for 60 min at 60-70° C. The slurry was then cooled to 0-10° C. in 4 h and post stirred for 2 h at 0-10° C. The solid was filtered off at 0-10° C. and the filter cake washed twice (displacement) with IPA (40.0 mL, 2.0 vol) at 0-25° C. The wet product was dried in the cabinet at 50° C. until constant weight was achieved to give the product (16.2 g) as a solid.

### Recrystallization:

A 500 mL reactor was three times flushed with nitrogen and crude (S)-6-(3-methoxypyrrolidin-1-yl)-2-phenylpyrimidine-4-carbonitrile (20.0 g, 71.34 mmol), activated charcoal (Norit CGP Super) and IPAc (200 mL, 10.0 vol) were charged at JT s 40° C. The slurry was then warmed to 65-75° C. and post stirred for 60 min at 65-75° C. The solution was filtered through a tempered (ca. 75° C.) pressure filter into a second 500 mL reactor. First reactor and filter were rinsed with IPAc (40.0 ml, 2.0 vol). The solution was concentrated to 4-5 vol at normal pressure at 85-95° C. Heptane (160.0 mL, 8.0 vol) was added at 85-95° C. and the solution subsequently cooled to 65-75° C. in 60 min. The obtained slurry was cooled to 0-10° C. in 3 h and post stirred for 2 h at 0-10° C. The solid was filtered off at 0-10° C. and the filter cake was washed (displacement) twice with IPAc/Heptane 1:2 v/v at 0-25° C. The wet product was dried in the cabinet at 50° C. until constant weight was achieved to give the product (16.8 g) as a solid.

### Example 2

### Synthesis of (S)-6-(3-methoxypyrrolidin-1-yl)-2-phenylpyrimidine-4-carboxylic acid sodium salt

A 500 mL reactor was three times flushed with nitrogen, and water (323 mL, 6.5 vol) was charged and warmed to 20-40° C. (S)-6-(3-methoxypyrrolidin-1-yl)-2-phenylpyrimidine-4-carbonitrile (50.0 g, 178 mmol, 1.0 eq.) and 2-propanol (532 mL, 10.6 vol) were added and the reaction mixture was warmed to 70-85° C. An aqueous solution of sodium hydroxide (30%, 29 mL, 0.58 vol) was added over 30 min via an addition funnel and the funnel was rinsed with water (5.0 mL, 0.1 vol). The reaction mixture was stirred for at least 6 h at 75-85° C., cooled to 45-55° C. over at least 2 h and stirred for additional 30 min at 45-55° C. The obtained suspension was cooled to 15-25° C. over at least 4 h and stirred for at least 30 min at 15-25° C. The product was filtered, and the filter cake was washed first with a mixture of 2-propanol (136 mL) and water (14 mL) and subsequently with toluene (150 mL). The wet product was dried in vacuo at 45-55° C. to give the product as a solid.

### Example 3

### Synthesis of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride in crystalline form 2 (as described in WO 2018/055016)

### Stage 1: Synthesis of 4-[(R)-2-tert-butoxycarbonylamino-3-(diethoxy-phosphoryl)-propionyl]-piperazine-1-carboxylic acid butyl ester

A 2.5 L glass reactor equipped with a mechanical stirrer and a dropping funnel was charged with toluene (780 mL, 3.9 vol), (R)-2-tert-butoxycarbonylamino-3-(diethoxy-phosphoryl)-propionic acid (200 g, 614.8 mmol, 1.0 eq.), piperazine-1-carboxylic acid butyl ester hydrochloride (141.0 g, 633.3 mmol, 1.03 eq.) and triethylamine (217.75 g, 2152 mmol, 3.5 eq.) and the temperature of the light slurry was adjusted to 10-20° C. T3P 50% w/w in toluene (430.4 g, 676.30 mmol, 1.10 eq.) was dosed directly into the reaction mixture over 1-2 h at 10-20° C. The dosage system was subsequently rinsed with 20 mL toluene (0.1 vol). The reaction mixture was aged for at least 1 h. The reaction mixture was transferred into an Erlenmeyer flask and water (800 mL, 4 vol) was charged to the reactor. The reaction mixture was quenched over at least 10 min at 10-25° C. on the water charged to the reactor. Then, 30% w/w caustic soda (123.0 g, 922.2 mmol, 1.5 eq.) was charged over at least 10 min at 10-25° C. Maximum volume: 2.6 L, 13 vol. The lower aqueous layer was drained at 15-25° C. (fast phase separation, no interphase). Water (200 mL, 1 vol) was added to the organic layer and the pH adjusted to 2.5-3.0 with 30% w/w sulfuric acid (about 241 g) at 15-25° C. The lower aqueous layer was drained (fast phase separation, no interphase). Water (200 mL, 1 vol) was added to the organic layer and the mixture stirred for at least 5 min. The phases were separated for at least 30 min and the lower aq. layer drained. The organic layer was concentrated at 40-60° C. (p=100-300 mbar) to ca. 30% w/w and a clear yellow solution was obtained.

### Stage 2: Synthesis of 4-[(R)-2-amino-3-(diethoxy-phosphoryl)-propionyl]-piperazine-1-carboxylic acid butyl ester

The batch was calculated on the amount of (R)-2-tert-butoxycarbonylamino-3-(diethoxy-phosphoryl)-propionic acid used for the preparation of Stage 1.

A 1.0 L glass reactor equipped with a mechanical stirrer, a dropping funnel and a distillation adaptor was charged with the solution of Stage 1 in toluene (500 g, prepared from 100 g (R)-2-tert-butoxycarbonylamino-3-(diethoxy-phosphoryl)-propionic acid). The solution was concentrated at 40-60° C. (50-250 mbar) to 215 g and transferred to a dropping funnel. Then, the reactor was charged with TFA (150 mL, 1.5 vol on (R)-2-tert-butoxycarbonylamino-3-(diethoxy-phosphoryl)-propionic acid) and the temperature adjusted to 45° C. Subsequently, the solution of Stage 1 was added dropwise at 45° C. over 2 h (addition controlled gas evolution). The batch was aged for 1 h and then distillation was started at 150 mbar at 45-50° C. The pressure was progressively lowered to 100 mbar while keeping the temperature at 45-50° C. The total post stirring time including the distillation was 4 h. The reaction mixture was quenched at 10-25° C. on a mixture of water (300 mL, 3 vol) and 25% ammonia (167.6 g, 8.0 eq.). Dichloromethane (300 mL, 3 vol) was added at 10-25° C. The lower DCM layer was separated and the aq. layer reextracted twice with DCM (150 ml, 1.5 vol). The combined DCM layers were washed with 20% KHCO₃ aq. (100 mL, 1 vol). Toluene was added (92 mL, 0.9 vol) and the organic layer concentrated at 40-60° C. (stop distillation when>60° C.). Subsequently more toluene (258 mL, 2.6 vol) was added and the solution concentrated at 40-60° C. (100-400 mbar) to 300 g to give the product as a yellow solution.

### Stage 3: Synthesis of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester

Stage 2 (100 g, 254.18 mmol, 1.0 eq., based on titration) was charged as a solution in toluene (about 226 g, 44.2% w/w), and water (200 mL, 2 vol) was added. The pH was adjusted to 4.0-5.0 with 33% HCl aq. (about 28 g) at 15-25° C. The Stage 2 containing aq. layer was separated and the organic layer discarded. The aq. solution of Stage 2 was diluted with HOBt monohydrate 3% in THF (274.8 g, 7.8 g HOBt monohydrate+300 mL THF) and (S)-6-(3-methoxypyrrolidin-1-yl)-2-phenylpyrimidine-4-carboxylic acid sodium salt (83.3 g, 259 mmol, 1.02 eq.) was added. The pH of the light slurry was adjusted to 5.0-5.5 (target: 5.2) with HCl 33%. At 15-25° C., EDC (58.47 g, 305.02 mmol, 1.2 eq.) was added in at least 10 portions over at least 1 h. The pH of the reaction mixture was monitored and kept in the range of 4.5-5.5 by the addition of 10% K2CO3 or 33% HCl aq. (a few milliliters). The pH was stable over most of the addition and only drops to <5.0 towards the end of the addition. During the addition, the reaction mixture turned biphasic and the solids progressively dissolved. The reaction mixture was stirred at 15-25° C. for 3 h. The reaction mixture was diluted with toluene (150 mL, 1.5 vol), and the aqueous layer drained at 15-25° C. Toluene (150 mL, 1.5 vol) was added at 15-25° C. and the organic layer washed successively with aqueous K₂CO₃ 10% w/w (2×150 mL, 2×1.5 vol) and water (100 ml, 1 vol). To the organic phase, toluene (150 mL, 1.5 vol) was added and the product solution was concentrated at 40-60° C. (150-300 mbar) to <300 g, diluted with acetic acid (500 mL, 5 vol) and concentrated at 40-60° C. (50-200 mbar) to <550 g; IPC: THF s 0.5%-a/a, toluene s 5.0%-a/a, water 0.5% w/w. The weight of the solution was adjusted to 686 g (25% w/w calc. on the theoretical yield) by addition of acetic acid.

### Stage 4: Synthesis of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride in crystalline form (I)

To a solution of Stage 3(171.5 g, 254.18 mmol) in AcOH (490 mL, 2.9 vol) was added ethanol (29.3 g, 635.45 mmol, 2.5 eq.). Then acetyl chloride (29.9 g, 381.27 mmol, 1.5 eq.) was added dropwise over at least 20 m, keeping the temperature at 25-35C. The reaction mixture was stirred 4 to 5 h at 30-C and then seeded with 0.5 g 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride seed crystals and stirred for 30 m at 30C. The obtained slurry was post stirred for another 14 h at 30° C. At 30° C., AcOEt (860 mL, 5 vol) was added dropwise over at least 2 h. The slurry was cooled to 20° C. over 1 h and aged for at least 2 h and then filtered. The wet product was washed with AcOEt (345 mL, 2 vol, displacement wash) and AcOEt (345 mL, 2 vol, slurry wash). The wet product was dried in the cabinet at 454C until constant weight with carrying gas to give the product (159.4 g, uncorrected) as a white to off-white crystalline solid.

TABLE 1
Characterisation data for COMPOUND•HCl in crystalline form (I)

| Technique | Data Summary | Remarks |
|---|---|---|
| XRPD | Crystalline | see FIG. 1 |
| ¹H-NMR | δ = 8.23 (t, 2H, J = 8 Hz), 7.72 (t, 1H, J = 8 Hz), | |
| (400 MHz, CD₃OD) | 7.63 (t, 2H, J = 8 Hz), 7.32 (s, 1H), 5.47-5.36 | |
| | (m, 1H), 4.33-4.11 (m, 4H), 3.95-3.67 (m, 7H), | |
| | 3.64-3.55 (m, 3H), 3.51-3.40 (m, 4H), 2.47-2.10 | |
| | (m, 4H), 1.72-1.62 (m, 2H), 1.49-1.38 (m, 2H), | |
| | 0.98 (t, 3H, J = 8 Hz). | |
| Side products (HPLC): | HYDROLYSIS PRODUCT: 0.2 to 0.4%-a/a | |
| | 4-((R)-3-(diethoxy-phosphoryl)-2-{[6-((S)-3- | |
| | methoxy-pyrrolidin-1-yl)-2-phenyl-pyrimidine-4- | |
| | carbonyl]-amino}-propionyl)-piperazine-1- | |
| | carboxylic acid butyl ester: <0.05%-a/a | |
| | 4-((R)-3-(ethoxy(hydroxy)phosphoryl)-2-{[6-((S)- | |
| | 3-methoxy-pyrrolidin-1-yl)-2-phenyl-pyrimidine- | |
| | 4-carbonyl]-amino}-propionyl)-piperazine-1- | |
| | carboxylic acid butyl ester: ≤0.2%-a/a | |

### Stage 5: Synthesis of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride in crystalline form 2 (as described in WO 2018/055016)

Stage 4 (30.0 g, 91.7% w/w, 42.0 mmol) was charged to the reactor and acetone/water 4:1 v/v (105 mL, 3.5 vol, pre-warmed to 50° C.) was added and a clear solution was formed. The solution was cooled to 30° C., seeded with 0.5 g seed crystals of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride and stirred for 30 min at 25-35° C. Acetone (360 mL, 12 vol) was added to the obtained slurry over 3 h at 25-35° C. The slurry was cooled to 0-10° C. over 2 h and post stirred for 60 min at 0-10° C. and then filtered. The wet product was washed with acetone (2×75 mL, 2.5 vol). The wet product was dried in the rotary evaporator with carrying gas (nitrogen gas saturated with water) at 20-35° C. until constant weight was achieved to give the product as a white solid in crystalline form 2 (as described in WO 2018/055016) in 92% yield.

Alternatively, the wet product may be dried in the absence of a carrying gas until a water content of not more than 8.2% w/w water.

### Reference Example 1: Cleavage of the diethoxy-phosphoryl-group of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester in a mixture of DCM and concentrated, aqueous hydrochloride acid

A solution of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester (1.05 g) in DCM (4.0 vol) was divided equally into two 25 mL screw topped vials. The solutions were treated with either 1.8 vol or 3.6 vol 32% w/w aqueous HCl and stirred at RT. Samples were taken at the timepoints given in table 2 and analyzed by HPLC to determine the relative amount of the hydrolysis product (R)-2-(6-((S)-3-methoxypyrrolidin-1-yl)-2-phenylpyrimidine-4-carboxamido)-3-phosphonopropanoic acid (HYDROLYSIS PRODUCT):

TABLE 2

| | 3.6 vol 32% HCl, 24 eq. | | 1.8 vol 32% HCl, 12 eq. | |
|---|---|---|---|---|
| | 4 h | 20 h | 4 h | 20 h |
| COMPOUND•HCl | 93.5 | 79.1 | 92.7 | 80.3 |
| [%-a/a] | | | | |
| HYDROLYSIS | 2.8 | 15.2 | 2.2 | 13.0 |
| PRODUCT | | | | |
| [%-a/a] | | | | |

### Reference Example 2: Cleavage of the diethoxy-phosphoryl-group of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester in concentrated, aqueous hydrochloride acid

A mixture of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester (200 mg, 0.30 mmol) in 37% w/w aqueous HCl was stirred under the conditions given in table 3. Samples were taken at the timepoints given in table 3 and analyzed by HPLC to determine the relative amount of the hydrolysis product (R)-2-(6-((S)-3-methoxypyrrolidin-1-yl)-2-phenylpyrimidine-4-carboxamido)-3-phosphonopropanoic acid (HYDROLYSIS PRODUCT):

TABLE 3

| Reaction Conditions | | Results | | |
|---|---|---|---|---|
| HCl | | | | HYDROLYSIS |
| 37% w/w | Temp. | time | COMPOUND•HCl | PRODUCT |
| (eq.) | [° C.] | [h] | [%-a/a] | [%-a/a] |
| 5 | RT | 2.5 | 56.5 | 0.42 |
| | | 24 | 87.9 | 6.4 |
| 5 | 40 | 2.5 | 93.0 | 3.7 |
| | | 24 | 72.8 | 16.5 |
| 10 | RT | 2.5 | 95.4 | 1.1 |
| | | 24 | 86.4 | 8.0 |

### Reference Example 3: Cleavage of the diethoxy-phosphoryl-group of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester in diluted, aqueous hydrochloride acid

A mixture of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester (200 mg, 0.30 mmol) in a mixture of 37% w/w aqueous HCl and water (see table 4) was stirred at RT under the conditions given in table 4. Samples were taken at the timepoints given in table 4 and analyzed by HPLC to determine the relative amount of the hydrolysis product (R)-2-(6-((S)-3-methoxypyrrolidin-1-yl)-2-phenylpyrimidine-4-carboxamido)-3-phosphonopropanoic acid (HYDROLYSIS PRODUCT):

TABLE 4

| Reaction Conditions | | Results | | |
|---|---|---|---|---|
| HCl | | | | HYDROLYSIS |
| 37% w/w | Water | time | COMPOUND•HCl | PRODUCT |
| (eq.) | [vol] | [h] | [%-a/a] | [%-a/a] |
| 30 | 2 vol | 1 | 57.9 | 0.36 |
| | | 4 | 93.0 | 2.1 |
| | | 24 | 87.8 | 11.0 |

### Example 4: Cleavage of the diethoxy-phosphoryl-group of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester with HCl in acetone

A mixture of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester (200 mg, 0.30 mmol) in acetone and HCl (see table 5) was stirred at RT under the conditions given in table 5. Samples were taken at the timepoints given in table 5 and analyzed by HPLC to determine the relative amount of the hydrolysis product (R)-2-(6-((S)-3-methoxypyrrolidin-1-yl)-2-phenylpyrimidine-4-carboxamido)-3-phosphonopropanoic acid (HYDROLYSIS PRODUCT):

TABLE 5

| | | Results | | |
|---|---|---|---|---|
| Reaction Conditions | | | | HYDROLYSIS |
| | Solvent | time | COMPOUND•HCl | PRODUCT |
| HCl | [vol] | [h] | [%-a/a] | [%-a/a] |
| HCl 37% w/W | acetone | 1 | 59.4 | 0.37 |
| (aq.); 20 eq. | (2 vol) | 3 | 91.0 | 1.55 |
| | | 4 | 94.5 | 2.33 |
| | | 26 | 79.9 | 13.5 |
| dry HCl | acetone | 1 | 20.3 | 0 |
| (4M in | (2 vol) | 4 | 44.5 | 0.22 |
| dioxane, | | 24 | 91.2 | 0.68 |
| 5 eq.) | | 96 | 97.4 | 1.09 |

### Example 5: Cleavage of the diethoxy-phosphoryl-group of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester with HCl in different solvents

HCl gas was gently bubbled for 20 m through a solution of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester in the respective solvent (see table 6) and the mixture was stirred at RT under the conditions given in table 6. Samples were taken at the timepoints given in table 6 and analyzed by HPLC to determine the relative amount of the hydrolysis product (R)-2-(6-((S)-3-methoxypyrrolidin-1-yl)-2-phenylpyrimidine-4-carboxamido)-3-phosphonopropanoic acid (HYDROLYSIS PRODUCT):

TABLE 6

| | | Results | | |
|---|---|---|---|---|
| Reaction Conditions | | | | HYDROLYSIS |
| reaction | Solvent | time | COMPOUND•HCl | PRODUCT |
| scale | [vol] | [h] | [%-a/a] | [%-a/a] |
| 200 mg, | Toluene | 2 | 11.0 | 0 |
| 0.30 mmol | (10 vol) | 3 | 11.2 | 0 |
| | | 22 | 52.9 | 0.34 |
| | | 48 | 72.4 | 0.40 |
| | | (ML) | | |
| | | 48 | 95.1 | 0 |
| | | (PPT) | | |
| 200 mg, | AcOMe | 1 | 14.5 | 0 |
| 0.30 mmol | (10 vol) | 18 | 86.2 | 0.44 |
| | | PPT*) | 97.8 | 0.28 |
| 200 mg, | AcOH | 2.5 | 97.8 | 0.5 |
| 0.30 mmol | (10 vol) | | | |
| 500 mg, | AcOH | 1 | 97.0 | 0.44 |
| 0.74 mmol | (5 vol) | 2 | 98.4 | 0.52 |
| 500 mg, | AcOH | 1 | 46.0 | 0.11 |
| 0.74 mmol | (2 vol) | 2 | 78.7 | 0.37 |
| | | 4 | 97.0 | 0.41 |
| 2.5 g, | AcOH | 1 | 14.2 | 0.05 |
| 3.7 mmol | (1.5 vol) | 3 | 80.7 | 0.23 |
| | | 5 | 98.3 | 0.42 |

ML: mother liquor;
PPT: precipitate;
*)after 18 h the precipitate was filtered and analyzed

### Example 6: Cleavage of the diethoxy-phosphoryl-group of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester with in-situ generated HCl

A mixture of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester (1.0 g), Ac₂O (4.95 eq.) and concentrated aqueous HCl (32% w/w, 1.5 eq) in AcOH (2.0 vol) was stirred at RT for 1.5 h, seeded with 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride crystals and further stirred at RT. After 14 h the reaction was diluted with AcOH (4 vol) and samples were taken at the time-points given in table 7 to determine the relative amount of the hydrolysis product (R)-2-(6-((S)-3-methoxypyrrolidin-1-yl)-2-phenylpyrimidine-4-carboxamido)-3-phosphonopropanoic acid (HYDROLYSIS PRODUCT):

TABLE 7

| | | HYDROLYSIS |
|---|---|---|
| time | COMPOUND•HCl | PRODUCT |
| [h] | [%-a/a] | [%-a/a] |
| 14 | 88.5 | 0.24 |
| 21 | 96.5 | 0.37 |

### Example 7: Cleavage of the diethoxy-phosphoryl-group of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester with in-situ generated HCl

A mixture of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester (1.0 g), AcCl (1.5 eq.) and ethanol (2.5 eq) in different volumes of AcOH (see table 8) was stirred at RT. Samples were taken at the time-points given in table 8 to determine the relative amount of the hydrolysis product (R)-2-(6-((S)-3-methoxypyrrolidin-1-yl)-2-phenylpyrimidine-4-carboxamido)-3-phosphonopropanoic acid (HYDROLYSIS PRODUCT):

TABLE 8

| | | | HYDROLYSIS |
|---|---|---|---|
| AcOH | time | COMPOUND•HCl | PRODUCT |
| (vol) | [h] | [%-a/a] | [%-a/a] |
| 1.5 vol | 2 | 6.7 | <0.05 |
| | 4 | 17.6 | <0.05 |
| | 21 | 87.6 | 0.22 |
| 2.5 vol | 2 | 24.1 | <0.05 |
| | 4 | 50.0 | <0.05 |
| | 21 | 98.8 | 0.44 |
| 4.0 vol | 2 | 28.2 | <0.05 |
| | 4 | 57.0 | <0.05 |
| | 21 | 98.7 | 0.44 |

### Example 8: Cleavage of the diethoxy-phosphoryl-group of 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester with in-situ generated HCl

A mixture of the starting material (SM) 4-((R)-3-(diethoxy-phosphoryl)-2-{[6-((S)-3-methoxy-pyrrolidin-1-yl)-2-phenyl-pyrimidine-4-carbonyl]-amino}-propionyl)-piperazine-1-carboxylic acid butyl ester (20 g), AcCl (1.5 eq.) and ethanol (2.5 eq) in AcOH (3 vol) was stirred at 35° C. for 4 h, seeded with 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride crystals, further stirred at 35° C. for additional 4 h, and cooled to RT. Samples were taken at the time-points given in table 9 to determine the relative amount of the hydrolysis product (R)-2-(6-((S)-3-methoxypyrrolidin-1-yl)-2-phenylpyrimidine-4-carboxamido)-3-phosphonopropanoic acid (HYDROLYSIS PRODUCT):

TABLE 9

| | | HYDROLYSIS | |
|---|---|---|---|
| time | COMPOUND•HCl | PRODUCT | SM |
| [h] | [%-a/a] | [%-a/a] | [%-a/a] |
| 0.5 | 8.7 | <0.05 | 76.5 |
| 2 | 45.9 | <0.05 | 40.1 |
| 4 | 76.5 | 0.10 | 16.8 |
| 6 | 87.4 | 0.21 | 8.6 |
| 21 | 98.7 | 0.48 | 0.13 |

### Example 9: Alternative procedures for the synthesis of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride in crystalline form 2 (as described in WO 2018/055016)

a) COMPOUND-HCl (2.0 g, 3.1 mmol) was dissolved in 44 mL acetone and 2.3 mL water at 65° C. The solution was cooled down to 55° C., seeded with 3% COMPOUND-HCl in crystalline form 2 and stirred for 1 h. The mixture was cooled to 15° C. at 3° C./h to give COMPOUND-HCl in crystalline form 2 (60% yield).

b) COMPOUND-HCl (2.0 g, 3.1 mmol) was dissolved in 6 mL acetone and 3.5 mL water at RT. The solution was added to a cooled mixture (5° C.) of 60 mL acetone containing 50 mg seeding crystals of COMPOUND-HCl in crystalline form 2 at a rate of 10 mL/h and stirred overnight to give COMPOUND-HCl in crystalline form 2 (78% yield).

c) COMPOUND-HCl (5.0 g, 7.6 mmol) was dissolved in a mixture of acetone and water (4:1 v/v, 20 mL) at 50° C. The solution was diluted with acetone (32.5 mL) and treated with seed crystals of COMPOUND-HCl in crystalline form 2 (100 mg). Acetone (38 mL) was added to the mixture within 1 h and the mixture was cooled to 5° C. at 2.8° C./h to give COMPOUND-HCl in crystalline form 2 (78% yield).

d) COMPOUND-HCl (18 g, 27.5 mmol) was dissolved in a mixture of acetone and water (4:1 v/v, 63 mL) at 65° C. The solution was cooled to 30° C., treated with seed crystals of COMPOUND-HCl in crystalline form 2 (90 mg) and stirred for 1 h. Acetone (216 mL) was added to the mixture within 1.5 h. The mixture was stirred for 1 h, cooled to 5° C. at 5° C./h and stirred for additional 2 h to give COMPOUND-HCl in crystalline form 2 (87% yield).

1. A process for the manufacturing of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester (COMPOUND), or of a hydrochloride salt thereof 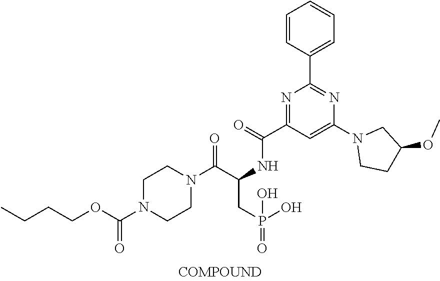 [SMILES: CCCCOC(=O)N1CCN(C(=O)[C@H](CP(=O)(O)O)NC(=O)c2cc(N3CC[C@H](OC)C3)nc(-c3ccccc3)n2)CC1]
said process comprising the reaction of a compound of formula (I) 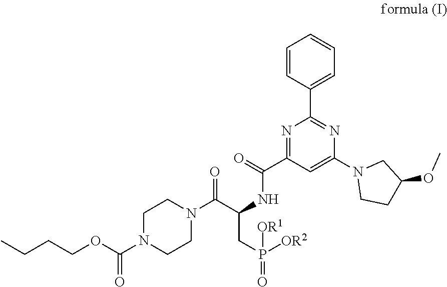
wherein R¹ and R² represent independently from each other (C₁₋₄)alkyl,
with hydrochloride in a mixture comprising an organic solvent and water,
wherein the organic solvent is acetone, toluene, R³C(O)OR⁴ or any mixture thereof, wherein R³ represents hydrogen or (C₁₋₂)alkyl and R⁴ represents hydrogen or (C₁₋₃)alkyl; and wherein the amount of water is less than 12 equivalents relative to the amount of compound of formula (I).

2. A process according to claim 1, wherein R¹ and R² are identical and represent methyl, ethyl, n-propyl, or iso-propyl.

3. A process according to claim 1, wherein R¹ and R² both represent ethyl.

4. A process according to claim 1, wherein the hydrochloride is added to the reaction mixture as hydrochloride gas or is generated in-situ by reaction of an electrophilic chloride source with a protic nucleophile.

5. A process according to claim 1, wherein the hydrochloride is generated in-situ by reaction of an electrophilic chloride source with a protic nucleophile.

6. A process according to claim 1, wherein the hydrochloride is generated in-situ by reaction of an electrophilic chloride source selected from (C₁₋₃)alkyl-C(O)Cl with a protic nucleophile selected from water and (C₁₋₄)alkanol.

7. A process according to claim 1, wherein the amount of hydrochloride that is added to the reaction mixture as hydrochloride gas; or that is generated in-situ by reaction of an electrophilic chloride source with a protic nucleophile, is between 0.9 and 5.0 equivalents relative to the amount of compound of formula (I).

8. A process according to claim 1, wherein the organic solvent is R³C(O)OR⁴ or any mixture thereof, wherein R³ represents hydrogen or (C₁₋₂)alkyl and R⁴ represents hydrogen or (C₁₋₃)alkyl.

9. A process according to claim 1, wherein the organic solvent is acetic acid.

10. A process according to claim 1, wherein the amount of water is between 0.8 and 2.0 equivalents relative to the amount of compound of formula (I).

11. A process according to claim 1, wherein the reaction is performed at a temperature between 20° C. and 40° C.

12. A process according to claim 1, wherein an anti-solvent is added to the reaction mixture, wherein the anti-solvent is selected from acetone, ethyl acetate or any mixture thereof.

13. A process according to claim 1, wherein the process further comprises the step of recrystallizing 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride (COMPOUND-HCl) in crystalline form (I) from a mixture of acetone and water.

14. A crystalline form of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride, characterized by the presence of peaks in the X-ray powder diffraction diagram at the following angles of refraction 2θ: 5.7°, 5.9°, and 12.9°.

15. A crystalline form according to claim 14, characterized by the presence of peaks in the X-ray powder diffraction diagram at the following angles of refraction 2θ: 5.1°, 5.7°, 5.9°, 11.0°, and 12.9°.

16. A crystalline form according to claim 14, characterized by the presence of peaks in the X-ray powder diffraction diagram at the following angles of refraction 2θ: 3.7°, 5.1°, 5.7°, 5.9°, 11.0°, 12.9°, 15.2°, 18.3°, 20.2°, and 21.0°.

17. A process according to claim 1, wherein R¹ and R² both represent ethyl; wherein the hydrochloride is generated in-situ by reaction of an electrophilic chloride source selected from (C₁₋₃)alkyl-C(O)Cl with a protic nucleophile selected from water and (C₁₋₄)alkanol; and wherein the organic solvent is R³C(O)OR⁴ or any mixture thereof, wherein R³ represents hydrogen or (C₁₋₂)alkyl and R⁴ represents hydrogen or (C₁₋₃)alkyl.

18. A process according to claim 17, wherein the hydrochloride is generated in-situ by reaction of acetyl chloride with ethanol.

19. A process according to claim 18, wherein the amount of water is between 0.8 and 2.0 equivalents relative to the amount of compound of formula (I).

20. A process according to claim 1, wherein the process comprises isolating 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester (COMPOUND), or of a hydrochloride salt thereof.

21. A process according to claim 1, wherein the reaction mixture is treated after being stirred for a stirring time of at least 3 hours with seeding crystals of 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride (COMPOUND-HCl).

22. A process according to claim 1, wherein the process comprises isolating 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride (COMPOUND-HCl) in crystalline form (I).

23. A process according to claim 21, wherein the process comprises isolating 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride (COMPOUND-HCl) in crystalline form (I).

24. A process according to claim 17, wherein the process further comprises the step of recrystallizing 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride (COMPOUND-HCl) in crystalline form (I) from a mixture of acetone and water.

25. A process according to claim 24, wherein the process comprises isolating 4-((R)-2-{[6-((S)-3-methoxy-pyrrolidin-1-yl)-2-phenyl-pyrimidine-4-carbonyl]-amino}-3-phosphono-propionyl)-piperazine-1-carboxylic acid butyl ester hydrochloride (COMPOUND-HCl) in crystalline form 2.
